(19) United States
(12) Patent Application Publication
(10) Pub. No.: US 2018/0232656 A1
(43) Pub. Date: Aug. 16, 2018

(54) Data Processing System with Machine Learning Engine to Provide System Disruption Detection and Predictive Impact and Mitigation Functions

(71) Applicant: Bank of America Corporation, Charlotte, NC (US)

(72) Inventors: Morgan S. Allen, Charlotte, NC (US); Joseph B. Castinado, Northglenn, CO (US); Stephen A. Corrado, Marvin, NC (US); Evan Sachs, New York, NY (US)

(21) Appl. No.: 15/429,654

(22) Filed: Feb. 10, 2017

(51) Int. Cl. G06N 99/00

(52) U.S. Cl. CPC G06N 99/005

(57) ABSTRACT

Systems for detecting potential disruptions in operation of the system and identifying and executing appropriate responses to mitigate impact of the system disruption are provided. In some examples, a computing platform may generate one or more machine learning datasets. The machine learning datasets may be generated based on data from various sources. In some arrangements, one or more content streams may be received and/or processed. The content streams may include data related to a current operating status of a system, current internal conditions and/or current external conditions. The content stream data may be used to determine a likelihood of a system disruption. Upon determining a likelihood of a system disruption, one or more potential responses may be generated. The potential responses may then be prioritized or ranked to identify a response that is most likely to be beneficial if executed. The system may then execute one or more of the identified responses.

### BACKGROUND

Aspects of the disclosure relate to electrical computers, data processing systems, and machine learning. In particular, one or more aspects of the disclosure relate to implementing and using a data processing system with a machine learning engine to provide system disruption detection functions and execute responses to prevent or mitigate impact of a system disruption.

Large enterprise organizations may deploy, operate, maintain, and use many different computer systems, which may provide many different services to various affiliated entities associated with a given computing environment. In addition, these organizations may also monitor changes in various external systems, disruptions of which may have an impact on the organization. Because of the number of systems in use and/or being monitored, as well as the amount of data being received in monitoring these systems, it may become increasingly difficult for network administrators, organization employees, and the like, to detect system disruptions, particularly in advance of the disruption, and identify and take appropriate action to mitigate impact of the disruption.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with monitoring a plurality of systems in use by an entity or organization to detect potential disruptions in operation of the system and identifying and executing appropriate responses to prevent or mitigate the impact of the system disruption.

In some examples, a system, computing platform, or the like, may generate one or more machine learning datasets. The one or more machine learning datasets may be generated based on data from various sources, including historical data associated with previous system disruptions, internal condition data related to internal conditions of the entity (e.g., at or near the time of the disruption), external condition data related to external conditions impacting the entity (e.g., at or near the time of the disruption), and the like. In some examples, one or more datasets may be generated by a second entity (e.g., different from the entity implementing the computing platform) and may be transmitted to the entity for use.

In some arrangements, one or more content streams may be received and/or processed. The content streams may include data related to a current operating status of one or more systems, current internal conditions and/or current external conditions. In some examples, the content streams may be received and/or processed in real-time.

The content stream data may be used to determine a likelihood of a system disruption for a system. The likelihood may be determined based on the data from the content stream and one or more machine learning datasets. Upon determining a likelihood of a system disruption, one or more potential responses may be generated. In some examples, the potential responses may be categorized. The potential responses may then be prioritized or ranked to identify a response that is most likely to be most beneficial if executed. The system may then execute one or more of the identified responses.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for implementing and using a data processing system with a machine learning engine to provide system disruption detection and implement responses to mitigate any system disruption in accordance with one or more aspects described herein;

FIGS. 2A-2D depict an illustrative event sequence for implementing and using a data processing system with a machine learning engine to provide system disruption detection and mitigation in accordance with one or more aspects described herein;

FIG. 3 depicts an illustrative method for implementing and using a data processing system with a machine learning engine to detect a likely system disruption and generate one or more responses to aid in mitigating an impact of the disruption, according to one or more aspects described herein;

FIG. 4 depicts an illustrative method for implementing and using a data processing system with a machine learning engine to detect a potential system disruption and generate responses to mitigate an impact of the system disruption, according to one or more aspects described herein;

FIG. 5 illustrates one example user interface for implementing and using a data processing system with a machine learning engine to provide system disruption detection functions according to one or more aspects described herein;

FIG. 6 illustrates another example user interface for implementing and using a data processing system with a machine learning engine to provide system disruption detection functions according to one or more aspects described herein;

FIG. 7 illustrates one example operating environment in which various aspects of the disclosure may be implemented in accordance with one or more aspects described herein; and

FIG. 8 depicts an illustrative block diagram of workstations and servers that may be used to implement the processes and functions of certain aspects of the present disclosure in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Some aspects of the disclosure relate to using machine learning to detect system disruptions or determine a likelihood of a system disruption. In some examples, system disruptions may include operational issues (e.g., potential failure of a system, failure to execute as expected, disruption due to natural disaster, upcoming maintenance for system, upcoming increase in volume of events being processed, unauthorized activity on an account, and the like) with one or more systems of an entity. Additionally or alternatively, system disruptions may include disruptions to systems external to the entity (e.g., stock markets, competitors, raw material suppliers, vendors, natural disaster, or the like) that may have an impact on one or more systems within the entity.

In some conventional arrangements, system disruptions may occur and might not be identified until the disruption has occurred. Additionally or alternatively, disruptions to external systems, such as a stock market, might have far reaching implications for a variety of systems within the entity. Accordingly, identification of the disruption or potential disruption at an early stage is critical to mitigating impact. However, given the number of systems and volume of data being processed, it is difficult for conventional systems to identify disruptions quickly and take action sufficiently quickly to mitigate the impact of the disruption.

Accordingly, aspects described herein provide for use of machine learning to monitor systems and predict one or more system disruptions, as well as identify one or more responses that should be executed to mitigate impact of the system disruption. For example, historical data, as well as data related to internal and external conditions, may be used to identify patterns in system disruptions, certain conditions internal to the entity, conditions external to the entity, and the like.

In some arrangements, data (e.g., streaming data) from various sources may be received by a system disruption detection computing platform. The data may be in the form of one or more content streams. In some examples, the content streams may include data associated with current operating status of one or more systems, as well as internal and external conditions that may impact the one or more systems being monitored. The content streams may be received and/or processed in real-time to determine, e.g., based on one or more machine learning datasets, a likelihood of a system disruption.

In some examples, the computing platform may then generate one or more potential responses to the system disruption. The responses may be generated in real-time and may be configured to mitigate an impact of the disruption. In some arrangements, the generated responses may be prioritized to identify one or more responses of a plurality of responses that is most likely to mitigate the impact or will have the greatest effect on mitigating the impact of the disruption. The computing platform may then execute the response in an effort to mitigate the impact of the system disruption.

These and various other arrangements will be discussed more fully below.

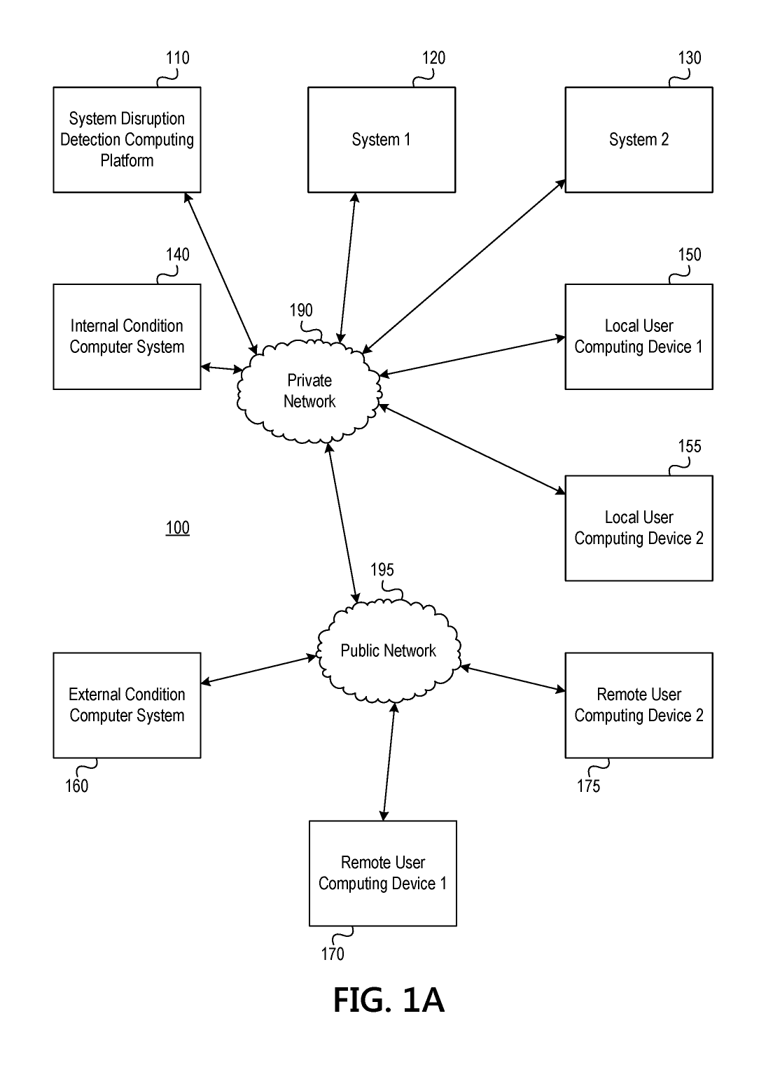

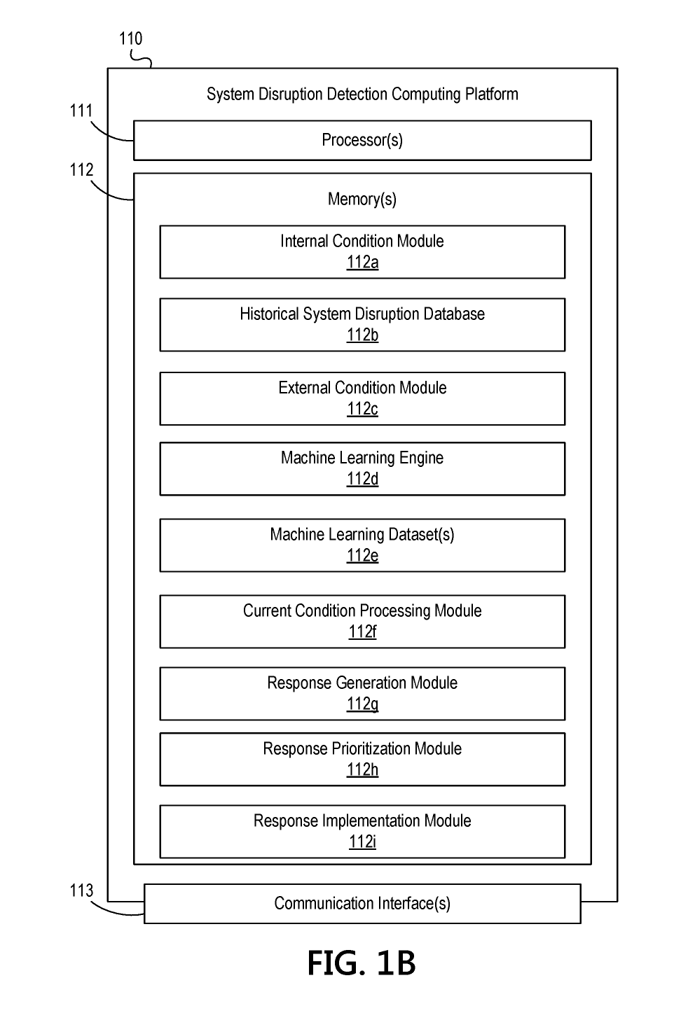

FIGS. 1A and 1B depict an illustrative computing environment for implementing and using a data processing system with a machine learning engine to provide system disruption detection and implement responses to mitigate any system disruption in accordance with one or more aspects described herein. Referring to FIG. 1A, computing environment 100 may include one or more computing devices and/or other computing systems. For example, computing environment 100 may include a system disruption detection computing platform 110, a first system 120, a second system 130, an internal condition computer system 140, an external condition computer system 160, a first local user computing device 150, a second local user computing device 155, a first remote user computing device 170, and a second remote user computing device 175.

System disruption detection computing platform 110 may be configured to host and/or execute a machine learning engine to provide automated system disruption detection and mitigation functions, as discussed in greater detail below. In some instances, system disruption detection computing platform 110 may monitor one or more systems, such as system 120, 130, determine a likelihood of a system disruption, based on the likelihood of the system disruption, generate a plurality of potential responses to the system disruption, prioritize the generated responses, and implement one or more responses, including transmitting signals or instructions to devices triggering one or more actions (e.g., increasing or decreasing central processing unit (CPU) usage, engaging alternate or additional servers, shutting down a system, or the like).

Systems 120, 130 may be one or more of a variety of systems employed by an entity to perform one or more business functions. Although two systems 120, 130 are shown in FIG. 1A, more or fewer systems may be monitored by the system disruption computing platform 110 without departing from the invention. Further, the systems 120, 130 may be systems employed by the entity (e.g., internal systems use to provide entity or enterprise business functions) or may be external systems, such as stock market indices, or the like.

Internal condition computer system 140 may be configured to monitor, collect, store and/or transmit data related to internal conditions of an entity. For example, the internal condition computer system 140 may include hardware and/or software configured to monitor business conditions (e.g., amount of cash available, staffing at one or more locations, day of the week, week of the month, day of the month, performance metrics, unauthorized activity, power failure, network or system access, and the like), as well as system or entity conditions (e.g., operating status of one or more systems, and the like). The internal condition computer system 140 may monitor conditions in real-time and may transmit condition information (e.g., a content stream) to the system disruption computing platform 110 to aid in identifying potential system disruptions.

External condition computer system 160 may be configured to monitor, collect, store and/or transmit data related to conditions external to the entity (e.g., market conditions, market risk indicators, prior year sales, and the like). For example, external condition computer system 160 may include hardware and/or software configured to monitor business conditions (e.g., market conditions, index conditions/status, media inquiries, social media alerts, earnings announcements, market risk indicators, market volatility indicators, telecommunications failure, and the like), as well as environmental conditions (e.g., incoming storm systems, potential or developing storm systems, potential natural disasters, and the like). The external condition computer system 160 may monitor conditions in real-time and may transmit condition information (e.g., a content stream) to the system disruption computing platform 110 to aid in identifying potential system disruptions.

Local user computing device 150, 155 and remote user computing device 170, 175 may be configured to communicate with and/or connect to one or more computing devices or systems shown in FIG. 1A. For instance, local user computing device 150, 155 may communicate with one or more computing systems or devices via network 190, while remote user computing device 170, 175 may communicate with one or more computing systems or devices via network 195. The local and remote user computing devices may be used to provide additional condition information, as well as to receive one or more notifications regarding system disruptions, recommended responses, and the like.

In one or more arrangements, first system 120, second system 130, internal condition computer system 140, external condition computer system 160, local user computing device 150, local user computing device 155, remote user computing device 170, and remote user computing device 175 may be any type of computing device capable of receiving a user interface, receiving input via the user interface, and communicating the received input to one or more other computing devices. For example, first system 120, second system 130, internal condition computer system 140, external condition computer system 160, local user computing device 150, local user computing device 155, remote user computing device 170, and remote user computing device 175 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of first system 120, second system 130, internal condition computer system 140, external condition computer system 160, local user computing device 150, local user computing device 155, remote user computing device 170, and remote user computing device 175 may, in some instances, be special-purpose computing devices configured to perform specific functions.

Computing environment 100 also may include one or more computing platforms. For example, and as noted above, computing environment 100 may include system disruption detection computing platform 110. As illustrated in greater detail below, system disruption detection computing platform 110 may include one or more computing devices configured to perform one or more of the functions described herein. For example, system disruption detection computing platform 110 may include one or more computers (e.g., laptop computers, desktop computers, servers, server blades, or the like).

As mentioned above, computing environment 100 also may include one or more networks, which may interconnect one or more of system disruption detection computing platform 110, first system 120, second system 130, internal condition computer system 140, external condition computer system 160, local user computing device 150, local user computing device 155, remote user computing device 170, and remote user computing device 175. For example, computing environment 100 may include private network 190 and public network 195. Private network 190 and/or public network 195 may include one or more sub-networks (e.g., local area networks (LANs), wide area networks (WANs), or the like). Private network 190 may be associated with a particular organization (e.g., a corporation, financial institution, educational institution, governmental institution, or the like) and may interconnect one or more computing devices associated with the organization. For example, system disruption detection computing platform 110, system 1 120, system 2 130, internal condition computer system 140, local user computing device 150, and local user computing device 155 may be associated with an organization (e.g., a financial institution), and private network 190 may be associated with and/or operated by the organization, and may include one or more networks (e.g., LANs, WANs, virtual private networks (VPNs), or the like) that interconnect system disruption detection computing platform 110, first system 120, second system 130, internal condition computer system 140, local user computing device 150, and local user computing device 155 and one or more other computing devices and/or computer systems that are used by, operated by, and/or otherwise associated with the organization. Public network 195 may connect private network 190 and/or one or more computing devices connected thereto (e.g., system disruption detection computing platform 110, first system 120, second system 130, internal condition computer system 140, local user computing device 150, and/or local user computing device 155) with one or more networks and/or computing devices that are not associated with the organization. For example, external condition computer system 160, remote user computing device 170, and remote user computing device 175 might not be associated with an organization that operates private network 190 (e.g., because external condition computer system 160, remote user computing device 170, and remote user computing device 175 may be owned, operated, and/or serviced by one or more entities different from the organization that operates private network 190, such as one or more customers of the organization and/or vendors of the organization, rather than being owned and/or operated by the organization itself or an employee or affiliate of the organization), and public network 195 may include one or more networks (e.g., the internet) that connect external condition computer system 160, remote user computing device 170, and remote user computing device 175 to private network 190 and/or one or more computing devices connected thereto (e.g., system disruption detection computing platform 110, first system 120, second system 130, internal condition computer system 140, local user computing device 150, and/or local user computing device 155).

Referring to FIG. 1B, system disruption detection computing platform 110 may include one or more processors 111, memory 112, and communication interface 113. A data bus may interconnect processor(s) 111, memory 112, and communication interface 113. Communication interface 113 may be a network interface configured to support communication between system disruption detection computing platform 110 and one or more networks (e.g., private network 190, public network 195, or the like). Memory 112 may include one or more program modules having instructions that when executed by processor(s) 111 cause system disruption detection computing platform 110 to perform one or more functions described herein and/or one or more databases that may store and/or otherwise maintain information which may be used by such program modules and/or processor(s) 111. In some instances, the one or more program modules and/or databases may be stored by and/or maintained in different memory units of system disruption detection computing platform 110 and/or by different computing devices that may form and/or otherwise make up system disruption detection computing platform 110. For example, memory 112 may have, store, and/or include an internal condition module 112a. Internal condition module 112a may store instructions and/or data that may cause and/or enable the system disruption detection computing platform 110 to receive, store and/or analyze conditions internal to an entity (e.g., received via a content stream). The internal condition module 112a may process received condition information (e.g., in real-time) to extract condition information that may be used to determine a likelihood of a system disruption (e.g., by comparison to one or more machine learning data sets).

Memory 112 may further have, store and/or include historical system disruption database 112b. Historical system disruption database 112b may store instructions and/or data associated with previous system disruptions (e.g., disruptions that occurred previously and have been rectified). The data from the historical system disruption database 112b may be used to generate one or more machine learning datasets (e.g., by machine learning engine 112d).

Memory 112 may further have, store and/or include an external condition module 112c. External condition module 112c may store instructions and/or data that may cause or enable system disruption detection computing platform 110 to receive, store, and/or analyze conditions external to the entity (e.g., received via a content stream). The external condition module 112c may process received condition information (e.g., in real-time) to extract condition information that may be used to determine a likelihood of a system disruption (e.g., by comparison with one or more machine learning datasets).

Memory 112 may further have, store and/or include a machine learning engine 112d and machine learning datasets 112e. Machine learning engine 112d and machine learning datasets 112e may store instructions and/or data that cause or enable systems disruption detection computing platform 110 to identify potential system disruptions, determine a likelihood of disruption, generate potential responses, and the like. The machine learning datasets 112e may be based on historical data related to previous system disruptions, as well as other data (e.g., known issues found on certain days of the month or week, current internal or external conditions, or the like). The machine learning engine 112d may receive data from a plurality of sources and, using one or more machine learning algorithms, may generate one or more machine learning datasets 112e. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. Additional or alternative machine learning algorithms may be used without departing from the invention.

The machine learning datasets 112e may include machine learning data linking one or more system conditions, internal conditions, external conditions, or the like, with one or more responses performable by the computing platform 110. For instance, the machine learning datasets may include data linking one or more system status conditions, internal conditions, and/or external conditions, with one or more responses to take to mitigate an impact of the potential system disruption. Thus, this data may enable the computing platform 110 to identify potential system disruptions, generate potential responses, and execute one or more responses.

In some examples, the machine learning datasets 112e may be generated by the machine learning engine 112d. Additionally or alternatively, one or more machine learning datasets 112e may be generated by a second entity, different from the entity implementing the computing platform 110 (such as a vendor, supplier, or the like) and may be transmitted to the computing platform 110, stored with datasets 112e and implemented, as will be discussed more fully herein.

Memory 112 may further include current condition processing module 112f. Current condition processing module 112f may store instructions and/or data that may cause or enable the system disruption detection computing platform 110 to receive, via a content stream from one or more systems being monitored, data from one or more systems (either internal entity systems or systems external to the entity). Systems that may be monitored may include systems providing business or enterprise functionality, stock exchanges or markets, systems providing internal personnel functionality, and the like. The received content stream may be processed (e.g., compared to one or more data sets) to determine a likelihood of a system disruption. In some examples, the received content stream may include content streams from internal condition computer system 140, external condition computer system 160, or may be processed along with content streams received from those devices.

Memory 112 may have, store, and/or include a response generation module 112g. Response generation module 112g may store instructions and/or data that may cause or enable systems disruption detection computing platform 110 to generate one or more potential responses to the likelihood of the system disruption in order to mitigate an impact of the system disruption. For instance, the response generation module 112g may generate one or more tactical or strategic responses that may aid in mitigating an impact of the system disruption. For instance, the response generation module 112f may determine that increasing or decreasing CPU usage, enabling additional or alternate servers, shutting down the system, or the like, may aid in mitigating the impact of the disruption. In some examples, one or more strategic responses may be generated, such as selling one or more assets in response to determining that a market disruption is likely. Various other strategic and/or business responses may also be generated. In some examples, the responses may be generated based on one or more machine learning datasets 112e. In some examples, the response generation module 112g may generate a category of response (e.g., tactical vs. strategic) for each generated response.

Memory 112 may have, store and/or include a response prioritization module 112h. The response prioritization module 112h may store instructions and/or data that may cause or enable system disruption detection computing platform 110 to prioritize the generated responses to identify one or more responses that are likely to reduce the potential impact of the system disruption the most, may provide the most immediate impact reduction, or the like. In some examples, the response prioritization module 112h may prioritize tactical responses separately from strategy responses.

Memory 112 may have, store and/or include a response implementation module 112i. The response implementation module 112i may store instructions and/or data that may cause or enable system disruption detection computing platform 110 to implement one or more of the generated responses. For example, in some arrangements, the response implementation module 112i may identify the highest priority response and may implement the response. Implementing the response may include transmitting a command or signal to one or more systems to modify CPU usage, engage or disengage additional or alternate servers, enable or disable (e.g., shut down) one or more systems, or the like. For instance, if a disruption is likely of system 1 120, and system 2 130 may provide backup capability for system 1, the response implementation module 112i may transmit a signal to shut down system 1 in anticipation of the potential disruption and enable system to act as a back-up system while system 1 is disable. This is merely one example of implementing a generated response and should not be viewed as limiting implementation of responses to only this example.

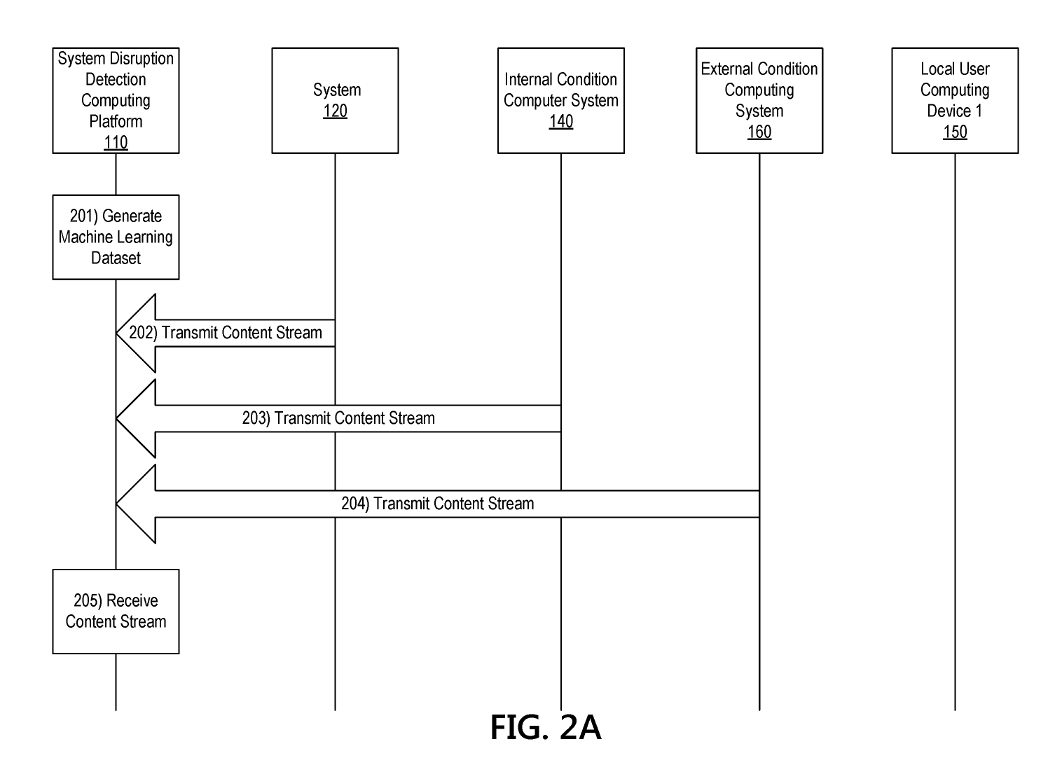

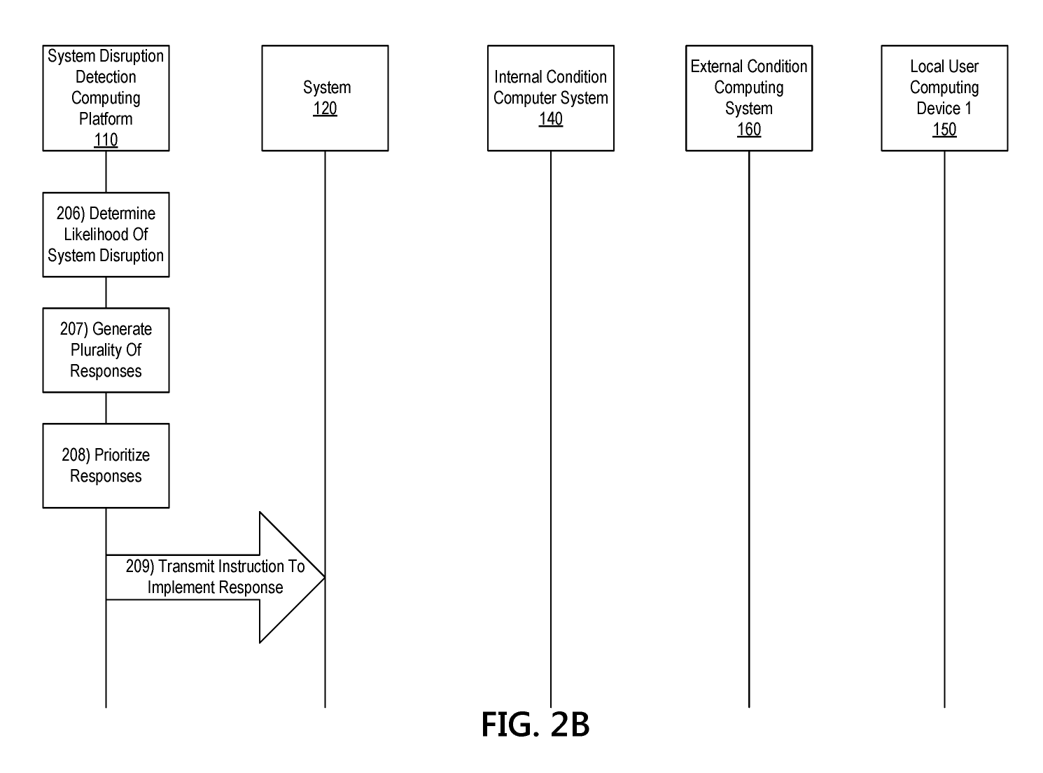

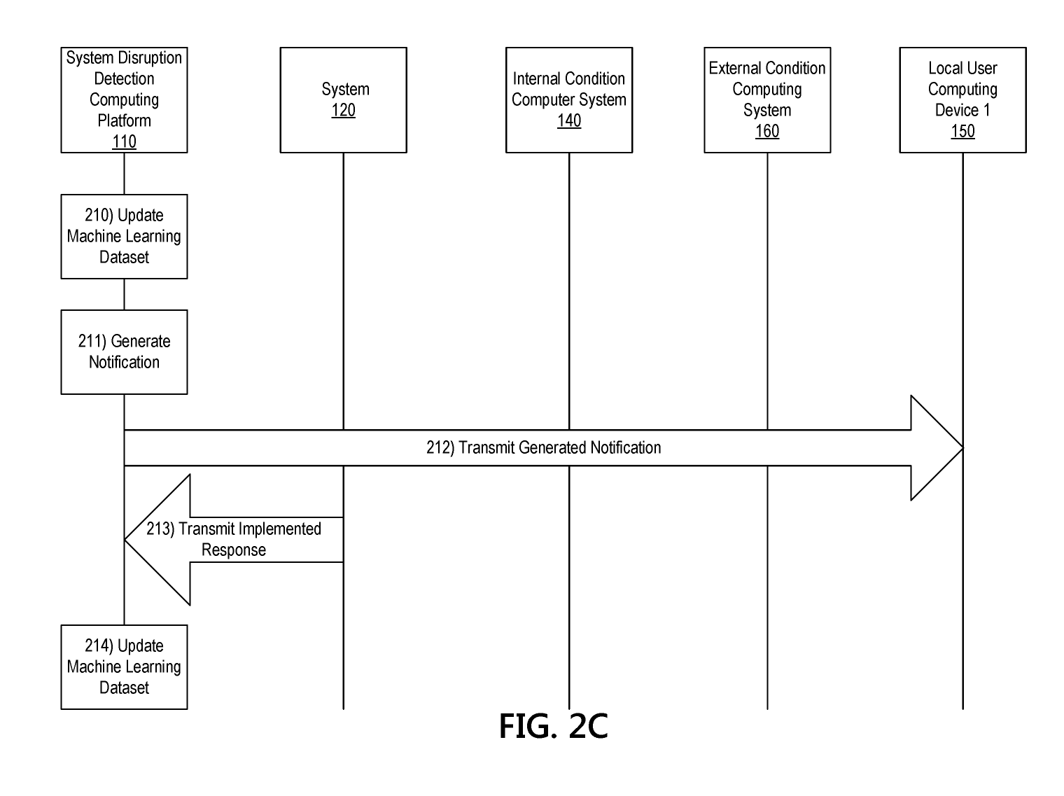

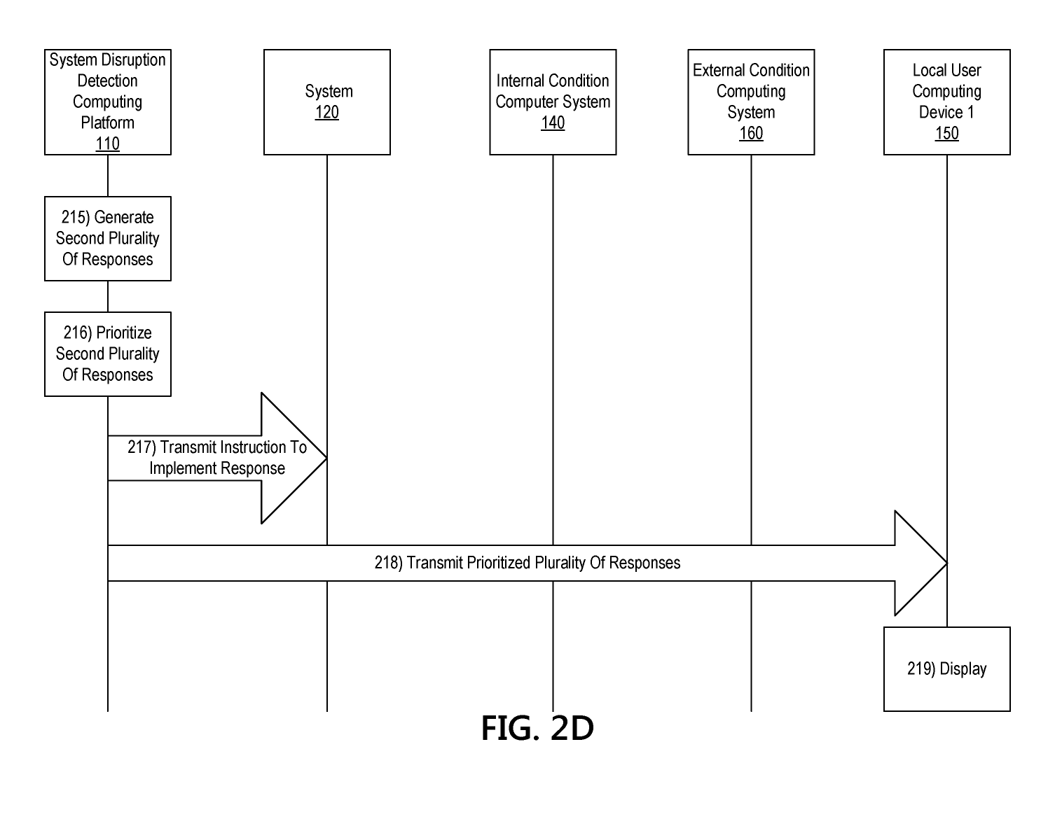

FIGS. 2A-2D depict an illustrative event sequence for implementing and using a data processing system with a machine learning engine to provide system disruption detection and mitigation in accordance with one or more aspects described herein. The events shown in the illustrative event sequence are merely one example sequence and additional events may be added, or events may be omitted, without departing from the invention.

Referring to FIG. 2A, at step 201, one or more machine learning datasets may be generated by a system disruption detection computing platform (e.g., by machine learning engine 112d). The datasets may be generated using one or more machine learning algorithms and may be generated based on data from various sources, such as historical system disruption data, internal condition data, external condition data, and the like.

At step 202, a content stream may be transmitting from one or more systems being monitored by the system disruption detection computing platform 110. For instance, system 120 may transmit a content stream including operational data, upcoming maintenance or update information, and the like. The content stream may be transmitted in real-time or near real-time. In step 203, a content stream may be received from internal condition computer system 140. The content stream may include data related to current internal conditions of the system, the entity, and the like, and may be transmitted in real-time or near real-time. For instance, the content stream may include scheduled system maintenance information, current day or month/week, identified upcoming needs (e.g., additional cash availability at one or more locations, additional staffing needs at one or more locations, and the like).

In step 204, a content stream may be transmitted from external condition computer system 160. The content stream may be transmitted in real-time or near real-time and may include data related to current external conditions, such as market conditions, index conditions, environmental conditions, and the like. In some examples, the content streams may be processed individually while in other examples, the content streams may be combined and processed as a single content stream.

In step 205, the content streams may be received by the system disruption detection computing platform 110.

With reference to FIG. 2B, in step 206, a likelihood of a system disruption may be determined based on the received content streams. For example, the received content streams may be analyzed based on the one or more machine learning datasets (which may include machine learning training data) to determine whether the conditions associated with the system, as well as internal and external conditions, indicate that a system disruption is likely. If a system disruption is likely based on the analysis, one or more proposed responses may be generated in step 207. The responses may include responses generated based on one or more machine learning datasets and may include tactical (e.g., to avoid or limit impact of a system disruption) and/or strategic/business (e.g., to aid in making business focused decisions based on the potential system disruption) responses. In some examples, each generate response may include a category (e.g., tactical, strategic, or the like), to aid in identify appropriate responses to implement.

In step 208, the generated plurality of responses may be prioritized. For instance, based on the machine learning datasets, the generated responses may be ranked or prioritized based on the responses likely to most limit the impact of the disruption, lessen the business impact of the disruption, or the like.

In step 209, one or more of the generated responses may be implemented. For instance, in some examples, a signal or command may be transmitted from the system disruption detection computing platform 110 to system 120 (or other system) directing the system to take one or more particular actions. For instance, the signal or command may include a command to increase to decrease CPU usage, enable or engage alternate or additional servers, disable one or more servers or systems, or the like. In some examples, the highest priority response may be automatically implemented by the system. In other examples, the ranked responses may be transmitted to, for instance, local computing device 150, 155, and displayed on a user interface which may receive a selection of a response to implement. Upon receiving user input selecting a response, an signal or command may be transmitted from the system disruption detection computing platform 110 to the system.

With reference to FIG. 2C, in step 210, one or more machine learning datasets may be updated in step 210. For instance, the most recent data received from the content streams may be added to the machine learning datasets. In addition, the generated responses and priority of the responses may also be used to update the one or more machine learning datasets.

In step 211, a notification may be generated. The notification may include one or more user interfaces identifying the prioritized list of responses, as well as any responses that have already been implemented. In step 212, the notification may be transmitted to the local user computing device 150 and the system disruption detection computing platform 110 may cause the interface to be displayed on the device 150.

In step 213, feedback may be transmitted from the system 120 to the system disruption detection computing platform. The feedback may be contained in a data stream and may include an indication that the instruction or command to implement the response was executed. In some examples, current condition data may also be transmitted in step 213 to understand whether the potential disruption has been avoided or impact mitigated. In step 214, the one or more machine learning datasets may be updated based on the received information regarding implementation of one or more responses. In some examples, the data associated with implementation of one or more responses may be considered a validation of the machine learning dataset or the generated outputs. This validation may then be used in updating the machine learning datasets.

With reference to FIG. 2D, in step 215, a second plurality of responses may be generated based on the updated machine learning datasets (and, in some examples an updated or additional content stream from one or more systems or devices received, for example, after a response has been implemented). For instance, based on current system conditions, as well as the implemented response, one or more additional responses may be generated. In step 216, the second plurality of responses may be prioritized based on the machine learning datasets. In step 217, an instruction, command or signal may be transmitted to system 120 to implement one or more of the generated responses.

Additionally or alternatively, a user interface may be generated including the prioritized second plurality of responses. The user interface may be transmitted from the system disruption detection computing platform 110 to one or more computing devices, such as local user computing device 150 in step 218. In step 219, the system disruption detection computing platform 110 may cause the user interface to be displayed on the computing device 150.

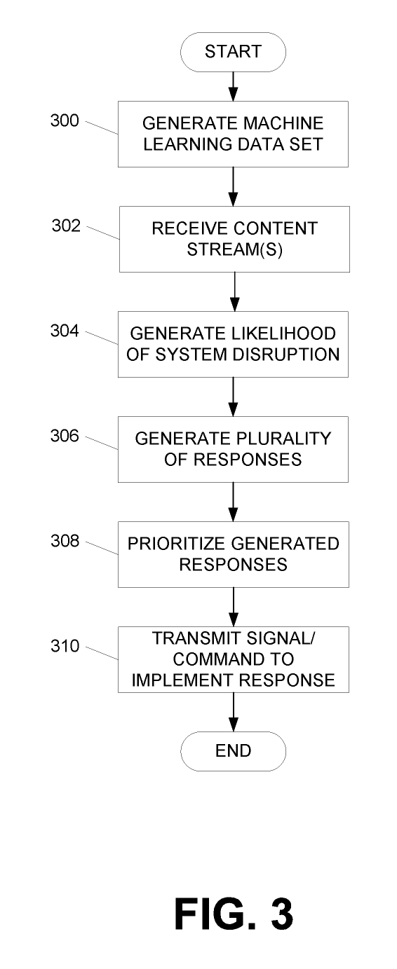

FIG. 3 is a flow chart illustrating one example method of detecting a likely system disruption and generating one or more responses to aid in mitigating an impact of the disruption, according to one or more aspects described herein. In step 300, one or more machine learning datasets may be generated. The machine learning datasets may be generated based on historical data (e.g., historical system disruption data), training data (e.g., known system issues, known responses to various issues, and the like), internal condition data, external condition data, and the like.

In step 302, one or more content streams may be received. In some examples, content streams may be received from one or more systems being monitored and including data related to operational readiness or status, expected maintenance and/or updates, and the like. Other content streams may be received from an internal condition computer system 140 and may include data related to current conditions of the entity implementing the system disruption detection computing platform 110, as well as external condition computer system 160, which may include data related to current conditions external to the entity (e.g., market conditions, environmental conditions, and the like).

In step 304, a likelihood of a system disruption may be determined based on the content streams and one or more machine learning datasets. In step 306, a plurality of potential responses to mitigate an impact of a system disruption may be generated. As discussed above, the plurality of responses may include modifying CPU usage, engaging or enabling additional or alternate servers, and the like.

In step 308, the generated responses may be prioritized to identify or rank the responses according to an effect the response may have on the impact of the system disruption. In step 310, one or more responses may be implemented by transmitting a signal to a system to implement the one or more responses.

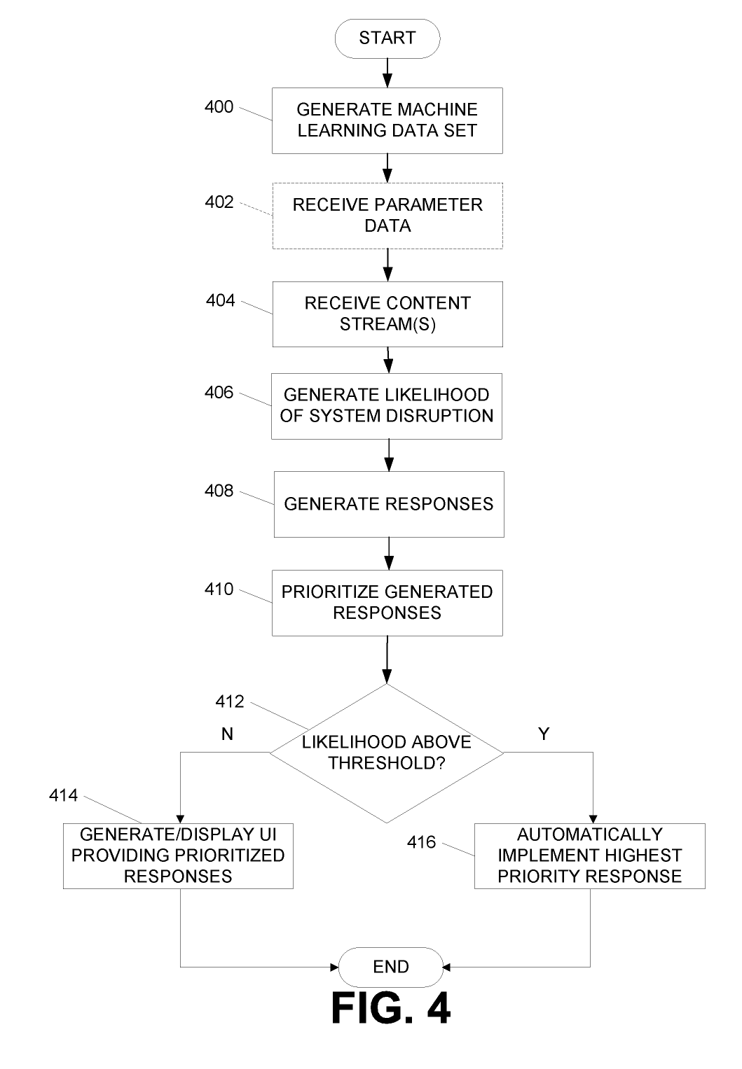

FIG. 4 illustrates another example method of detecting a potential system disruption and generating responses to mitigate an impact of the system disruption. In step 400, one or more machine learning datasets may be generated. Similar to the arrangements discussed above, the machine learning datasets may be generated using various machine learning algorithms and may be based on historical data, condition data, and the like.

In optional step 402, one or more parameters or customization parameters may be received by the system. For example, in some arrangements, one or more parameters may be customized (e.g., by a user, system administrator, or the like). The parameters may include options for criteria for when to automatically implement a response (e.g., the first priority response), threshold for automatically implementing, criteria for when to display the generated responses, a number of responses to display, type of responses to display, and the like. In some examples, these parameters may be predetermined by the system and, thus, step 402 may be omitted. In other arrangements, they may received from a user, as discussed above. In some examples, the parameters may be modified (e.g., by a user or by the system) based on updated received data, current system status, current internal or external conditions, and/or one or more updated machine learning datasets.

In step 404, one or more content streams may be received. As discussed above, the content streams may be received from one or more systems being monitored, as well as from internal condition computer system 140 and/or external condition computer system 160. In step 406, a likelihood of a system disruption may be generated or determined based on the received content streams and the one or more machine learning datasets.

In step 408, one or more potential responses to the system disruption may be generated. The one or more responses may be responses configured to mitigate an impact of the system disruption on the system, entity, or the like. In step 410, the generated responses may be prioritized to, for example, rank the response that is most likely to limit the impact in a highest position.

In step 412, the determined likelihood of the disruption may be compared to a predetermined threshold to determine whether the likelihood is at or above the predetermined threshold. If, in step 412, the likelihood is at or above the predetermined threshold, the system disruption detection computing platform 110 may automatically implement the highest priority response in step 416. For example, the system disruption detection computing platform 110 may transmit a signal or command to one or more systems, devices, or the like, to implement the response. As discussed above, implementing the response may include modifying available CPU usage, engaging alternate or additional devices, such as servers, and the like.

If, in step 412, the likelihood is not at or above the threshold, the computing platform 110 may generate a user interface providing the generated responses (e.g., in order of priority) in step 414. The computing platform 110 may then cause the user interface to display on, for example, local user computing device 150. A user may then select a response to implement.

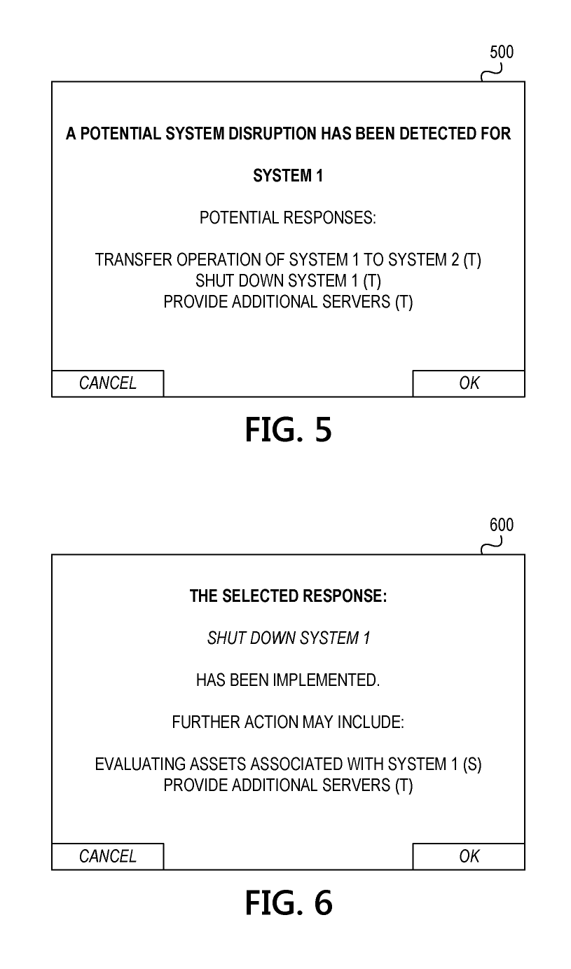

FIG. 5 illustrates one example user interface for displaying the generated responses according to one or more aspects described herein. The user interface 500 includes an identification of the system for which a potential disruption has been detected. The interface 500 also includes a list of available responses. In some examples, the category of response (e.g., T for tactical, S for strategic, or the like) may also be provided. The user interface 500 may be interactive such that a user may select one or more responses to implement. Selection of a response may cause the system disruption detection computing platform 110 to transmit a signal or instruction to one or more systems to execute the selected response.

FIG. 6 illustrates one example user interface for displaying secondary responses after a first response has been implemented, according to one or more aspects described herein. For example, upon a first response being implemented, one or more machine learning datasets may be updated and a second plurality of responses may be generated, prioritized, and the like. User interface 600 includes identification of the initial or previous response implemented. The user interface may further include a list of additional responses generated by the system. The responses may include various different categories of response. Similar to interface 500, interface 600 may be interactive such that a user may select one or more responses to implement. Selection of one or more responses may cause the system disruption detection computing platform 110 to transmit a signal, instruction, or command to one or more systems or devices to execute the selected response.

As discussed herein, the use of machine learning allows the computing platform to efficiently and accurately process vast amounts of data to evaluate and monitor various systems and the operational status of the systems to determine a likelihood of a system disruption. Machine learning may also aid in generating one or more appropriate responses to aid in mitigating an impact of any system disruption.

As discussed above, in some arrangements, a system disruption may include an operational issue with a system internal to an entity. Additionally or alternatively, a system disruption may include a disruption to a market or exchange, such as a stock market, or the like. Accordingly, responses generated to mitigate impact of the different types of systems may vary. For instance, both tactical and strategic responses may be generated for any type of system disruption. In some examples, if a market disruption is likely, there may be tactical responses (e.g., engaging or enabling additional computing resources in anticipation of increased trading, or the like) as well as strategic responses (e.g., recommendations to buy or sell particular assets based on the likelihood of the market disruption) that are generated and/or executed. In another example, if a particular system of the entity is likely to be disrupted (e.g., offline), there are tactical (e.g., transferring operation of the system to backup or alternate servers, or the like) as well as strategic responses (e.g., transmitting a notification to customers in advance of the disruption or early on in the disruption to make them aware) that may be generated and/or executed.

The arrangements described herein also allow for continued monitoring of systems, conditions, and the like, to update machine learning data sets and generate revised or additional recommendations based on responses executed, changing internal or external conditions, or the like. For instance, if a system disruption is likely, a plurality of responses may be generated and one response may be implemented. Implementation of the response may cause modifications to the operational status of the system. Additional content streams may be received by the computing platform, and, based on updated machine learning datasets generated based on the executed response, additional information, and the like, one or more additional or alternate responses may be generated based on this updated information. Accordingly, the system may continuously monitor situations to generate revised and up-to-date recommended responses in real-time or near real-time, in order to quickly react to any potential disruptions.

In some arrangements, failure to take an action (e.g., implement one or more recommended responses) may result in the system generating alternative responses and/or automatically implementing one or more responses. For example, the system may generate a first prioritized list of responses. If the first response listed is not executed within a predetermined period of time, that response may no longer be the highest priority or ranked response. Accordingly, after the predetermined period of time has expired (e.g., without the response being executed) the system may generated revised recommended responses which may include the same first recommended response or a different first recommended response based on the current condition information. In some examples, upon expiration of the predetermined period of time, the first recommended response may be automatically executed.

In some examples, display of the generated responses may be customizable. For instance, a number of responses provided may be limited (e.g., to avoid providing too many options for selection). In another example, a user may request to have more tactical responses than strategy responses provided, or vice versa. Accordingly, one or more users may customized the number, type, display, and the like, of the responses recommended.

In some examples, the identification of a likely system disruption may be used to proactively modify maintenance and/or update schedules. For instance, if current conditions indicate a likely disruption to a market, systems related to or supporting the market or functions associated with the market that were scheduled for maintenance may have the maintenance postponed until the likelihood of disruption is addressed or has passed. The system disruptions and associated recommendations may also be used to identify recurring issues or potential recurring issues and proactively address potential maintenance issues.

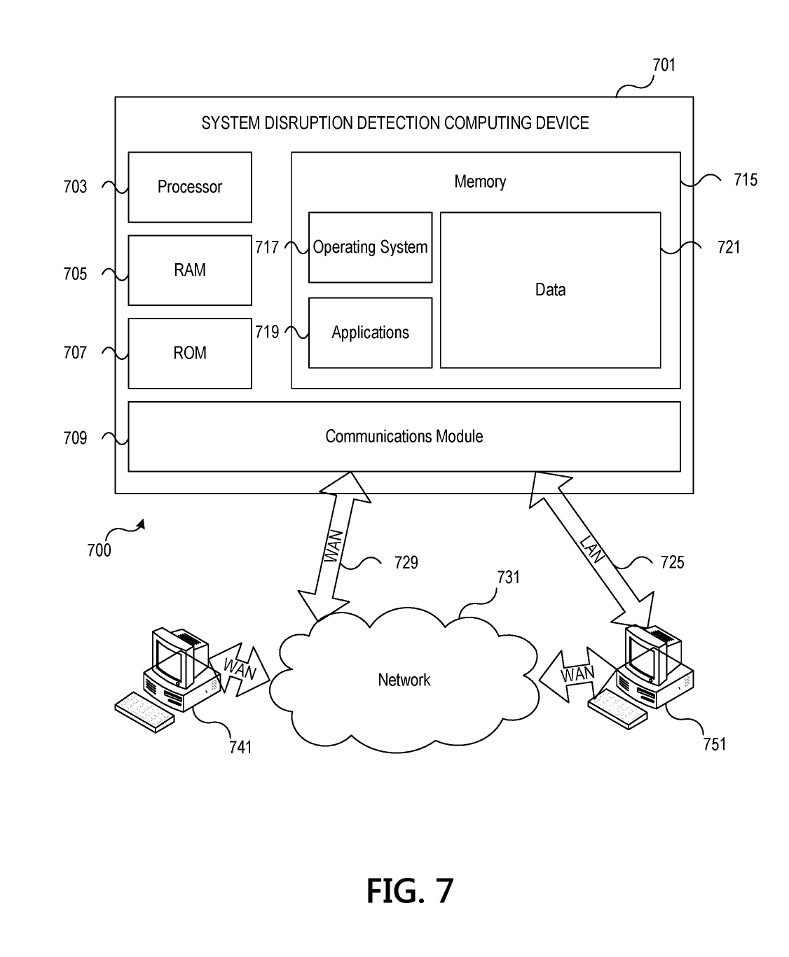

FIG. 7 depicts an illustrative operating environment in which various aspects of the present disclosure may be implemented in accordance with one or more example embodiments. Referring to FIG. 7, computing system environment 700 may be used according to one or more illustrative embodiments. Computing system environment 700 is only one example of a suitable computing environment and is not intended to suggest any limitation as to the scope of use or functionality contained in the disclosure. Computing system environment 700 should not be interpreted as having any dependency or requirement relating to any one or combination of components shown in illustrative computing system environment 700.

Computing system environment 700 may include system disruption detection computing device 701 having processor 703 for controlling overall operation of system disruption detection computing device 701 and its associated components, including random-access memory (RAM) 705, read-only memory (ROM) 707, communications module 709, and memory 715. System disruption detection computing device 701 may include a variety of computer readable media. Computer readable media may be any available media that may be accessed by system disruption detection computing device 701, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 701.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed embodiments is contemplated. For example, aspects of method steps disclosed herein may be executed on a processor on system disruption detection computing device 701. Such a processor may execute computer-executable instructions stored on a computer-readable medium.

Software may be stored within memory 715 and/or storage to provide instructions to processor 703 for enabling system disruption detection computing device 701 to perform various functions. For example, memory 715 may store software used by system disruption detection computing device 701, such as operating system 717, application programs 719, and associated database 721. Also, some or all of the computer executable instructions for system disruption detection computing device 701 may be embodied in hardware or firmware. Although not shown, RAM 705 may include one or more applications representing the application data stored in RAM 705 while system disruption detection computing device 701 is on and corresponding software applications (e.g., software tasks) are running on system disruption detection computing device 701.

Communications module 709 may include a microphone, keypad, touch screen, and/or stylus through which a user of system disruption detection computing device 701 may provide input, and may also include one or more of a speaker for providing audio output and a video display device for providing textual, audiovisual and/or graphical output. Computing system environment 700 may also include optical scanners (not shown). Exemplary usages include scanning and converting paper documents, e.g., correspondence, receipts, and the like, to digital files.

System disruption detection computing device 701 may operate in a networked environment supporting connections to one or more remote computing devices, such as computing devices 741 and 751. Computing devices 741 and 751 may be personal computing devices or servers that include any or all of the elements described above relative to system disruption detection computing device 701.

The network connections depicted in FIG. 7 may include local area network (LAN) 725 and wide area network (WAN) 729, as well as other networks. When used in a LAN networking environment, system disruption detection computing device 701 may be connected to LAN 725 through a network interface or adapter in communications module 709. When used in a WAN networking environment, system disruption detection computing device 701 may include a modem in communications module 709 or other means for establishing communications over WAN 729, such as network 731 (e.g., public network, private network, Internet, intranet, and the like). The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other computing system environments or configurations. Examples of computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like and are configured to perform the functions described herein.

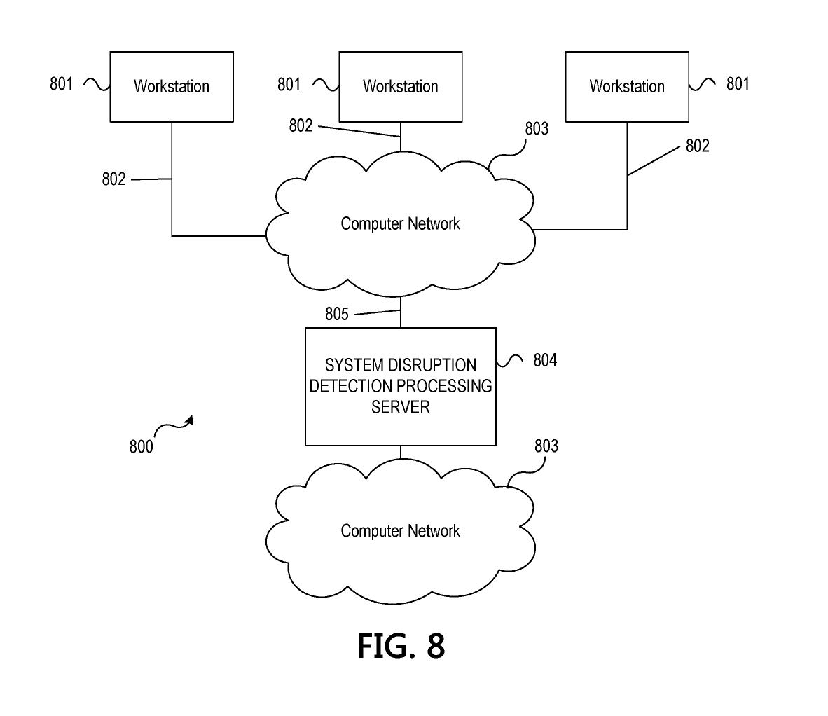

FIG. 8 depicts an illustrative block diagram of workstations and servers that may be used to implement the processes and functions of certain aspects of the present disclosure in accordance with one or more example embodiments. Referring to FIG. 8, illustrative system 800 may be used for implementing example embodiments according to the present disclosure. As illustrated, system 800 may include one or more workstation computers 801. Workstation 801 may be, for example, a desktop computer, a smartphone, a wireless device, a tablet computer, a laptop computer, and the like, configured to perform various processes described herein. Workstations 801 may be local or remote, and may be connected by one of communications links 802 to computer network 803 that is linked via communications link 805 to system disruption detection processing server 804. In system 800, system disruption detection processing server 804 may be any suitable server, processor, computer, or data processing device, or combination of the same, configured to perform the functions and/or processes described herein. Server 804 may be used to process received content streams to determine a likelihood of a system disruption, generate responses, prioritize responses, and the like.

Computer network 803 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 802 and 805 may be any communications links suitable for communicating between workstations 801 and system disruption detection processing server 804, such as network links, dial-up links, wireless links, hard-wired links, as well as network types developed in the future, and the like.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A system disruption detection computing platform, comprising:
at least one processor;
a communication interface communicatively coupled to the at least one processor; and
memory storing computer-readable instructions that, when executed by the at least one processor, cause the system disruption detection computing platform to:
receive, via the communication interface, a first content stream associated with current conditions of a system;
responsive to receiving the first content stream associated with the current conditions of a system, generate, based on the first content stream and a machine learning dataset, a likelihood of a system disruption;
generate, based on the likelihood of a system disruption and the machine learning dataset, a first plurality of responses to mitigate an impact of the system disruption;
prioritize the generated first plurality of responses based on a category of each response of the first plurality of responses; and
implementing a first priority response of the prioritized first plurality of responses to mitigate the impact of the system disruption.

2. The system disruption detection computing platform of claim 1, wherein the category of each response of the first plurality of responses is one of: tactical and strategic.

3. The system disruption detection computing platform of claim 1, wherein the first plurality of responses includes at least one of: modifying central processing unit (CPU) usage, shutting down the system, and transferring operation of the system to alternate servers.

4. The system disruption detection computing platform of claim 1, wherein the first plurality of responses includes at least one of: increasing staffing at a location and ordering additional cash for one or more locations.

5. The system disruption detection computing platform of claim 1, further including instructions that, when executed, cause the system disruption detection computing platform to:
determine whether the likelihood of the system disruption is at or above a predetermined threshold;
responsive to determining that the likelihood of the system disruption is at or above the predetermined threshold, automatically implementing the first priority response; and
responsive to determining that the likelihood of the system disruption is not at or above the predetermined threshold, displaying the generated first plurality of responses on a display of a computing device.

6. The system disruption detection computing platform of claim 1, further including instructions that, when executed, cause the system disruption detection computing platform to:
receive a second content stream associated with current internal conditions of an entity, and
wherein generating the likelihood of the system disruption is further based on the second content stream.

7. The system disruption detection computing platform of claim 6, further including instructions that, when executed, cause the system disruption detection computing platform to:
receive a third content stream associated with current external conditions of the entity, and
wherein generating the likelihood of the system disruption is further based on the third content stream.

8. The system disruption detection computing platform of claim 1, wherein the first content stream, second content stream, and third content stream are received in real-time.

9. The system disruption detection computing platform of claim 1, wherein the machine learning dataset includes historical data associated with a plurality of system disruptions including internal conditions associated with the plurality of system disruptions and external conditions associated with the plurality of system disruptions.

10. The system disruption detection computing platform of claim 1, wherein a system disruption may include a system internal to an entity or a system external to an entity and having a potential impact on the entity.

11. The system disruption detection computing platform of claim 1, further including instructions that, when executed, cause the computing platform to:
after implementing the first priority response, receive an updated content stream associated with current conditions of the system;
update the machine learning dataset based on implementing the first priority response;
generate, based on the updated machine learning dataset and updated content stream, a second plurality of responses to mitigate the impact of the system disruption; and
display the generated second plurality of responses.

12. A method, comprising:
at a computing platform comprising at least one processor, memory, and a communication interface:
receiving, by the at least one processor and via the communication interface, a first content stream associated with current conditions of a system;
responsive to receiving the first content stream associated with the current conditions of a system, generating, by the at least one processor and based on the first content stream and a machine learning dataset, a likelihood of a system disruption;
generating, by the at least one processor and based on the likelihood of a system disruption and the machine learning dataset, a plurality of responses to mitigate an impact of the system disruption;
prioritizing, by the at least one processor, the generated plurality of responses based on a category of each response of the plurality of responses; and
implementing, by the at least one processor, a first priority response of the prioritized plurality of responses to mitigate the impact of the system disruption.

13. The method of claim 12, wherein the category of each response of the plurality of responses is one of: tactical and strategic.

14. The method of claim 12, wherein the plurality of responses includes at least one of: modifying central processing unit (CPU) usage, shutting down the system, and transferring operation of the system to alternate servers.

15. The method of claim 12, wherein the plurality of responses includes at least one of: increasing staffing at a location and ordering additional cash for one or more locations.

16. The method of claim 12, further including:
determine, by the at least one processor, whether the likelihood of the system disruption is at or above a predetermined threshold;
responsive to determining that the likelihood of the system disruption is at or above the predetermined threshold, automatically implementing, by the at least one processor, the first priority response; and
responsive to determining that the likelihood of the system disruption is not at or above the predetermined threshold, displaying the generated plurality of responses on a display of a computing device.

17. The method of claim 12, further including:
receiving, by the at least one processor, a second content stream associated with current internal conditions of an entity, and
wherein generating the likelihood of the system disruption is further based on the second content stream.

18. The method of claim 17, further including:
receiving, by the at least one processor, a third content stream associated with current external conditions of the entity, and
wherein generating the likelihood of the system disruption is further based on the third content stream.

19. The method of claim 12, wherein the first content stream, second content stream, and third content stream are received in real-time.

20. The method of claim 12, wherein the machine learning dataset includes historical data associated with a plurality of system disruptions including internal conditions associated with the plurality of system disruptions and external conditions associated with the plurality of system disruptions.

21. One or more non-transitory computer-readable media storing instructions that, when executed by a computing platform comprising at least one processor, memory, and a communication interface, cause the computing platform to:
receive, via the communication interface, a first content stream associated with current conditions of a system;
responsive to receiving the first content stream associated with the current conditions of a system, generate, based on the first content stream and a machine learning dataset, a likelihood of a system disruption;
generate, based on the likelihood of a system disruption and the machine learning dataset, a plurality of responses to mitigate an impact of the system disruption;
prioritize the generated plurality of responses based on a category of each response of the plurality of responses; and
implementing a first priority response of the prioritized plurality of responses to mitigate the impact of the system disruption.

22. The one or more non-transitory computer-readable media of claim 21, wherein the category of each response of the plurality of responses is one of: tactical and strategic.

23. The one or more non-transitory computer-readable media of claim 21, wherein the plurality of responses includes at least one of: modifying central processing unit (CPU) usage, shutting down the system, and transferring operation of the system to alternate servers.

24. The one or more non-transitory computer-readable media of claim 21, wherein the plurality of responses includes at least one of: increasing staffing at a location and ordering additional cash for one or more locations.

25. The one or more non-transitory computer-readable media of claim 21, further including instructions that, when executed, cause the computing platform to:
determine whether the likelihood of the system disruption is at or above a predetermined threshold;
responsive to determining that the likelihood of the system disruption is at or above the predetermined threshold, automatically implementing the first priority response; and
responsive to determining that the likelihood of the system disruption is not at or above the predetermined threshold, displaying the generated plurality of responses on a display of a computing device.

26. The one or more non-transitory computer-readable media of claim 21, further including instructions that, when executed, cause the system disruption detection computing platform to:
receive a second content stream associated with current internal conditions of an entity, and
wherein generating the likelihood of the system disruption is further based on the second content stream.

27. The one or more non-transitory computer-readable media of claim 26, further including instructions that, when executed, cause the system disruption detection computing platform to:
receive a third content stream associated with current external conditions of the entity, and
wherein generating the likelihood of the system disruption is further based on the third content stream.

28. The one or more non-transitory computer-readable media of claim 21, wherein the first content stream, second content stream, and third content stream are received in real-time.

29. The one or more non-transitory computer-readable media of claim 21, wherein the machine learning dataset includes historical data associated with a plurality of system disruptions including internal conditions associated with the plurality of system disruptions and external conditions associated with the plurality of system disruptions.
